(19) United States
(12) Patent Application Publication
(10) Pub. No.: US 2026/0094425 A1
(43) Pub. Date: Apr. 2, 2026

(54) METHODS AND APPARATUS FOR OBJECT DETECTION AND CLASSIFICATION USING MACHINE LEARNING BASED PROCESSES

(71) Applicant: NV5 Geospatial Solutions. Inc., Hollywood, FL (US)

(72) Inventors: Christopher LEES, Cheyenne, WY (US); Michael Bayer, Fairport, NY (US); Zachary Norman, Broomfield, CO (US); Atle Borsholm, Louisville, CO (US)

(73) Assignee: NV5 Geospatial Solutions. Inc., Hollywood, FL (US)

(21) Appl. No.: 18/903,601

(22) Filed: Oct. 1, 2024

(51) Int. Cl. G06V 10/82; G06V 10/776

(52) U.S. Cl. CPC G06V 10/82; G06V 10/776

(57) ABSTRACT

Systems and methods employing machine learning processes to detect objects within images are provided. In some examples, a first trained machine learning model, such as a trained neural network, identifies regions in image data that contain one or more features of interest. During this classification process, the first trained machine learning model divides the input data into smaller sized regions, and processes the regions to identify whether one or more features of one or more classes are present in each region. The first trained machine learning model generates output data characterizing the regions with features. A second trained machine learning model, such as an object detector or pixel segmentation network, receives the output data from the first trained machine learning model. The second trained machine learning model processes the image data to detect features only within the regions identified by the received output data.

### FIELD OF THE INVENTION

The disclosure relates generally to image object detection and, more particularly, to detecting and classifying objects within images using machine learning based processes.

### BACKGROUND

Machine learning models, such as convolutional neural networks (CNNs), are often used to identify objects within digital images. For instance, applications such as surveying applications, computer vision applications, gaming applications, security applications, healthcare applications, and autonomous driving applications, among many others, rely on machine learning models to detect and classify objects within captured images. These machine learning based processes, however, are computational intensive requiring considerable amounts of processing power, processing time, and memory. In addition, the more processing power and memory is required to carry out these processes, the higher the potential costs become. Moreover, often times these machine learning based processes suffer from false negative, and false positive object detections. A false negative can include a missed or misidentified object, while a false positive can include a misclassified object. As such, there are opportunities to address these and other drawbacks of machine learning based object detection processes.

### SUMMARY

The embodiments employ machine learning based processes that includes the use of multiple (e.g., two) machine learning models (e.g., neural networks). A first machine learning model is trained to identify regions in image data that include one or more features of interest. Based on the first machine learning model's output, a second machine learning model (e.g., a feature detector such as an object detector or pixel segmentation network), processes the image data only in the identified regions to classify features. As such, because the second machine learning model detects features only in identified regions (e.g., rather than throughout the entire image), the embodiments can more quickly and efficiently identify and classify objects within image data, among other advantages.

For example, in some embodiments, an apparatus includes a memory device, and at least one processor communicatively coupled to the memory device. The at least one processor is configured to receive image data (e.g., geospatial data, Light Detection and Ranging (LIDAR) data, camera data, video data, etc.) characterizing a captured image. The at least one processor is also configured to apply a first trained machine learning process to the image data and, based on the application of the first trained machine learning process to the image data, generate first output data characterizing regions of the image data that include at least one object. Further, the at least one processor is configured to apply a second trained machine learning process to the first output data and, based on the application of the second trained machine learning process to the first output data, generate second output data characterizing a classification of the at least one object in at least one of the regions. The at least one processor is also configured to store the second output data in a data repository.

In some embodiments, a method by at least one processor includes receiving image data characterizing a captured image. The method also includes applying a first trained machine learning process to the image data and, based on the application of the first trained machine learning process to the image data, generating first output data characterizing regions of the image data that include at least one object. Further, the method includes applying a second trained machine learning process to the first output data and, based on the application of the second trained machine learning process to the first output data, generating second output data characterizing a classification of the at least one object in at least one of the regions. The method also includes storing the second output data in a data repository.

In some embodiments, a non-transitory computer readable medium stores instructions. The instructions, when executed by at least one processor, cause at least one processor to perform operations. The operations include receiving image data characterizing a captured image. The operations also include applying a first trained machine learning process to the image data and, based on the application of the first trained machine learning process to the image data, generating first output data characterizing regions of the image data that include at least one object. Further, the operations include applying a second trained machine learning process to the first output data and, based on the application of the second trained machine learning process to the first output data, generating second output data characterizing a classification of the at least one object in at least one of the regions. The operations also include storing the second output data in a data repository.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 illustrates an object detection and classification system, in accordance with some embodiments;

FIG. 2 illustrates a computing device, in accordance with some embodiments;

FIGS. 3A and 3B illustrate portions of an object detection and classification system, in accordance with some embodiments;

FIG. 4 illustrates portions of an object detection and classification system, in accordance with some embodiments;

FIGS. 5A, 5B, and 5C illustrate the detection of objects in an image, in accordance with some embodiments;

FIGS. 6A, 6B, and 6C illustrate the detection of objects in an image, in accordance with some embodiments;

FIG. 7 illustrates a flowchart of an exemplary method to detect objects in images using trained machine learning processes, in accordance with some embodiments;

FIGS. 8A and 8B illustrate flowcharts of exemplary methods to train machine learning processes, in accordance with some embodiments;

FIG. 9 illustrates a flowchart of an exemplary method to generate graphical user elements of detected objects using machine learning processes, in accordance with some embodiments; and

FIG. 10 illustrates a graphical user interface to configure machine learning processes, in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “communicatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

Machine learning processes, such as deep learning processes, can include training a network (e.g., a neural network) with substantial amounts of data and for extended periods of time (e.g., hours, days). Upon completion of the training process, the trained network may still fail to detect trained features. For example, the trained network may not be generalized enough to identify various features. As another example, a trained neural network may suffer from errant detections due to confusion between features and background information. For instance, the network may suffer from false negatives, and false positives. A false negative is a missed feature or misidentified target, whereas false positives can be misclassified features or background identified as a given feature. Detail oriented networks, such as object detector or pixel segmentation networks, can identify features on a per object basis. These types of networks tend to be process intensive, taking additional time and resources compared to other types of networks.

To address these and other issues, the object detection and classification process discussed herein employs a multiple model approach, such as two neural networks. A first trained machine learning model, such as a trained neural network, identifies regions in input data (e.g., image data) that contain one or more features of interest. During this classification process, the first trained machine learning model divides the input data into smaller sized regions (i.e., grid regions). The grid regions are then processed to identify whether one or more features of one or more classes are present in each region. The first trained machine learning model generates output data characterizing any regions with corresponding features. A second trained machine learning model, such as an object detector or pixel segmentation network, receives the output data from the first trained machine learning model. The second trained machine learning model processes the image data to detect features only within the regions determined to include one or more features of interest.

Among other advantages, the object detection and classification process can drastically reduce the time required to identify features in image data. Additionally, the object detection and classification process can reduce false positives and false negatives, as well as post processing techniques that may otherwise require. Persons of ordinary skill in the art having the benefit of these disclosures would recognize additional advantages as well.

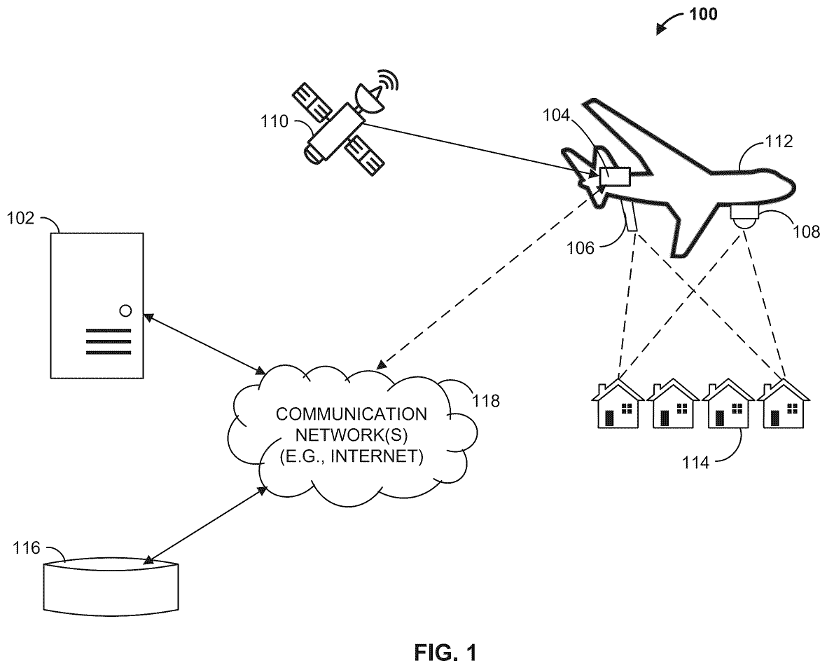

Turning to the drawings, FIG. 1 illustrates a block diagram of an object detection and classification system 100 that includes an aircraft 112 flying over a scene 114 (e.g., houses). Aircraft 112 includes a laser scanning system 106 (e.g., laser and corresponding LIDAR sensor), an imagery sensor 108 (e.g., camera), and a computing device 104. Laser scanning system 106 is operable to transmit a laser beam (e.g. laser pulses) to scene 114 and detect reflections with the LIDAR sensor to generate LIDAR data associated with three-dimensional (3D) measurements (e.g., x, y, z positional measurements). Imagery sensor 108 is operable to capture images of scene 114. Imagery sensor 108 may be a high resolution camera such as a charge-coupled device (CCD) camera, or any suitable camera. Although this example illustrates aircraft 112, in other examples, any other suitable collection vehicle, such as a helicopter, a car, or one or more tripods, may be employed. In addition, although a laser scanning system 106 capturing LIDAR data is illustrated in this example, systems that capture other types of geospatial data, image data, video data, or any other suitable data may be employed in other examples.

Computing device 104 may be communicatively coupled to any suitable satellite navigation systems or any suitable positional system. In this example, computing device 104 is communicatively coupled to the Global Positioning System (GPS). For example, computing device 104 may receive latitude and longitude data from GPS satellite 110. Computing device 104 may further be communicatively coupled to an inertial navigation system (INS) of the aircraft 112. The INS system may measure roll, pitch, and heading of the laser scanning system 106.

Object detection and classification system 100 also includes object detection and classification (ODC) computing device 102 and data repository 116. Each of computing device 104 and ODC computing device 102 may each include any hardware or hardware and software combination that allows for processing data. For example, each can include one or more processors, one or more field-programmable gate arrays (FPGAs), one or more application-specific integrated circuits (ASICs), one or more state machines, digital circuitry, or any other suitable circuitry. For example, each of computing device 104 and ODC computing device 102 can be a computer, a workstation, a laptop, a server, or any other suitable computing device. In addition, each can transmit and receive data over communication network 118.

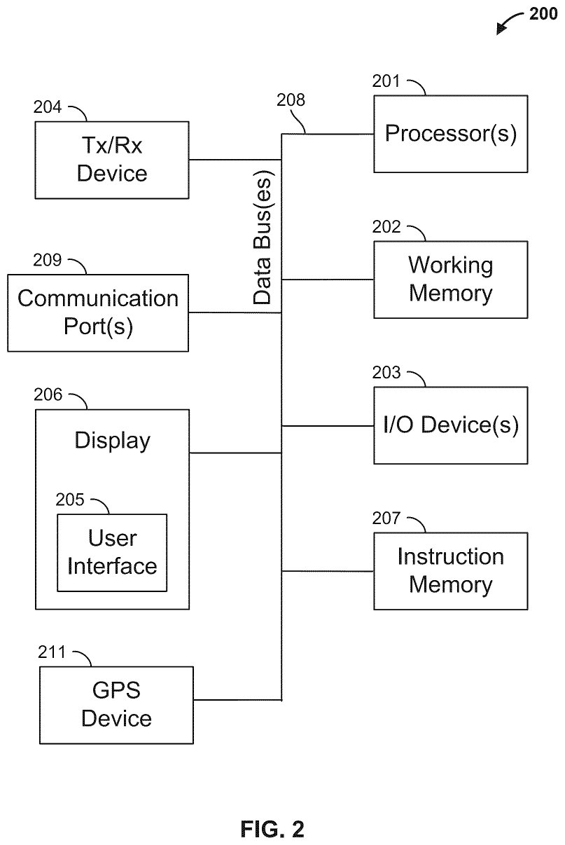

For example, FIG. 2 illustrates an exemplary computing device 200. Computing device 200 may be an example of computing device 104 and ODC computing device 102. Computing device 200 can include one or more processors 201, working memory 202, one or more input/output devices 203, instruction memory 207, a transceiver 204, one or more communication ports 209, a display 206 with a user interface 205, and a global positioning system (GPS) device 211, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. Processors 201 can be configured to perform a certain function or operation by executing code, stored on instruction memory 207, embodying the function or operation. For example, processors 201 can be configured to execute code stored in instruction memory 207 to perform one or more of any function, method, or operation disclosed herein.

Additionally, processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of ODC computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allow for the transfer (e.g., uploading or downloading) of data, such as LIDAR data or image data.

Display 206 can be any suitable display, and may display user interface 205. User interfaces 205 can enable user interaction with computing device 200. In some examples, a user can interact with user interface 205 by engaging input-output devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. Processor(s) 201 is operable to receive data from, or send data to, a network, such as communication network 118 of FIG. 1, via transceiver 204.

GPS device 211 may be communicatively coupled to the GPS and operable to receive position data from the GPS. For example, GPS device 211 may receive position data identifying a latitude, longitude, and altitude from a satellite (e.g., satellite 110) of the GPS. Based on the position data, computing device 200 may determine a 3-dimensional (e.g., X, Y, and Z) location.

Referring back to FIG. 1, data repository 116 can be a remote storage device, such as a cloud-based server, a disk (e.g., a hard disk), a memory device on another server, a networked computer, or any other suitable remote storage. ODC computing device 102 is operable to communicate with data repository 116 over communication network 118. For example, ODC computing device 102 may store data to, or read data from, data repository 116. In some examples, computing device 104 is operable to communicate with data repository 116 over communication network 118.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

In some examples, laser scanning system 106 may scan scene 114 to generate LIDAR data, and provide the LIDAR data to computing device 104. The LIDAR data may include a plurality of points, where each point is associated with a three dimensional (3D) measurement (e.g., x, y, z measurement values). Computing device 104 may store the LIDAR data in a memory device, such as data repository 116. Similarly, imagery sensor 108 may take images of scene 114, and may provide the images (i.e., image data) to computing device 104. Computing device 104 may store the images in the memory device.

ODC computing device 102 may obtain image data (e.g., LIDAR data, image data from imagery sensor 108) for an area, such as for scene 114, and may apply machine learning processes (e.g., algorithms) to the obtained image data to detect, for example, rooftops. As described herein, the machine learning processes may include a trained region network (e.g., a first trained neural network) and a trained feature network (e.g., a second trained neural network). The trained region network is configured to divide the each image into regions, and determine if each region includes at least a minimum number of features (e.g., 1) of one or more predetermined classes (e.g., rooftops, cars, etc.). For example, ODC computing device 102 may apply the trained region network to image data received from imagery sensor 108 and, in response, the trained region network may generate region output data characterizing one or more regions of the image data, where each region includes at least one object. For instance, each object can be any one of a rooftop, a car, a truck, or a parking lot. The trained region network may be a residual network (ResNet), for example. The region output data may include, for each region, a confidence score indicating a probability that the region includes a feature.

Further, the machine learning processes may include a trained feature network that receives, as input, the region output data generated by the trained region network. The trained feature network is configured to generate feature output data that characterizes features within each region identified by the received region output data. The trained feature network may be a pixel segmentation network (e.g., a convolutional neural network such as U-Net) or an object detection network (e.g., a one-stage object detection model such as RetinaNet), for example. In other examples, the trained feature network may include model architectures such as, but not limited to, segmentation, object detection, instance segmentation, panoptic classification, and any suitable future models that may be developed and can be trained to generate feature output data as described herein. The feature output data may identify a particular area of the image (i.e., within a region), and may include a confidence score indicating a probability that the particular area of the image includes a particular feature (e.g., a rooftop).

In some instances, the trained feature network detects features within a window that includes a region, where the window extends past the region (e.g., in all directions) by a predetermined amount (e.g., a predetermined number of pixels) to detect features that may be on the border of an identified region. For instance, each region may cover a square of image data that is 224×224 pixels. The window, however, may include the region and further extend to cover a square of image data that is 300×300 pixels.

This strategy for optimized deep learning classification saves considerable time and provides better results than, for instance, a feature detector alone. The trained region network identifies regions of interest where features exist, efficiently narrowing down the search space. The generated output data indicates whether features are present in each of the various regions. The trained feature network performs selective inference only in the proposed regions. The computational expense of these networks is drastically reduced by processing image data only in the regions with features as determined by the trained region network. By avoiding exhaustive feature detection across an entire image, processing power and time are reduced. Moreover, false positive and false negative detections may be reduced, as the trained feature network operates only within the regions the trained region network determined to include features.

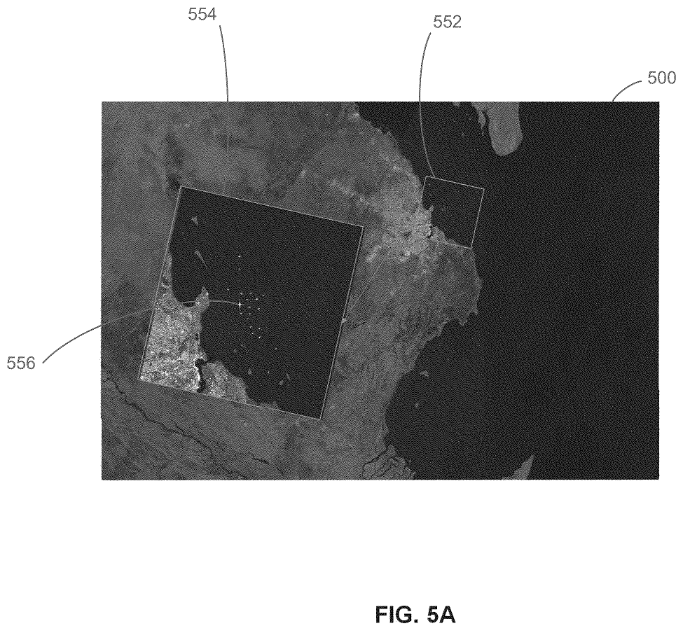

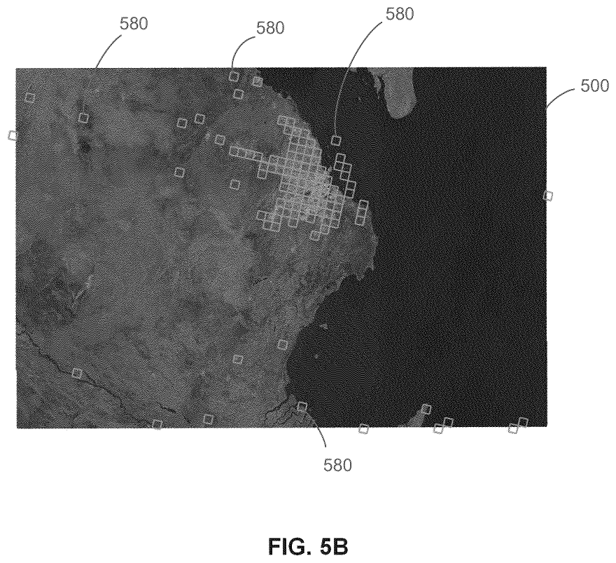

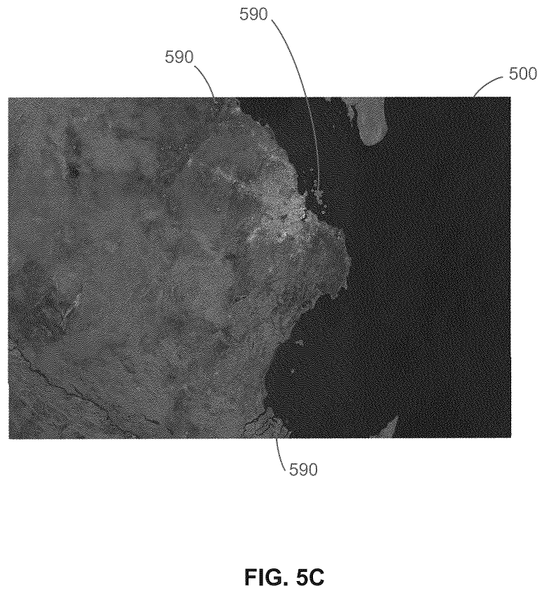

FIG. 5A, for example, illustrates an image 500 that may be captured by, for example, imagery sensor 108. Image 500 illustrates a coast that may include ships and other features. Zoom-in view box 554 of area 552 illustrates lighter areas 556 that may be ships. ODC computing device 102 may generate feature vectors based on image 500 (e.g., RGB pixel vectors), and may input the feature vectors to the trained region network. Based on the inputted feature vectors, the trained region network may generate region output data characterizing regions that may include at least one feature of one or more predetermined classes (e.g., classes the region network is trained to detect).

For example, FIG. 5B illustrates regions 580 of image 500 that include at least one feature. Each region may include a predetermined number of pixels. In this example, each region 580 is a square shape, although in other examples, each region 580 can be of other shapes. Only the areas of image 500 that are covered by a region 580 will be processed by the trained feature network. ODC computing device 102 may input region output data characterizing the regions 580 to the trained feature network. Based on the inputted region output data, the trained feature network generates feature output data characterizing a particular feature within the regions 580. As described herein, the trained feature network is configured to detect one or more particular features, such as, but not limited to, vehicles (e.g., aircraft, ships, boats, cars, trucks, etc.), roadways, infrastructure (e.g., utilities, oil and gas, facilities management, rooftops), damage assessment, disaster response (e.g., floods, forest fires), precision agriculture, or search and rescue, among other examples.

For instance, FIG. 5C illustrates features 590 identified within image 500. The features 590 may be ships, for example, and the feature network may be trained specifically to detect ships within image data. Because the trained region network processed the image 500 to detect regions 580 with at least one object, and the trained feature network processed image data only within the regions 580 (as opposed to the entire image 500), the features 590 can be detected in less time and with reduced processing needs.

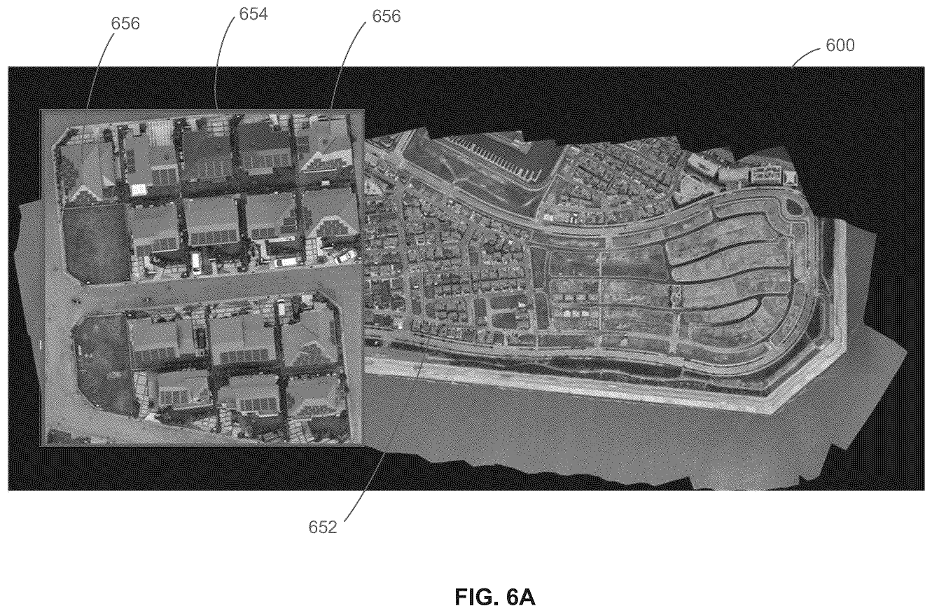

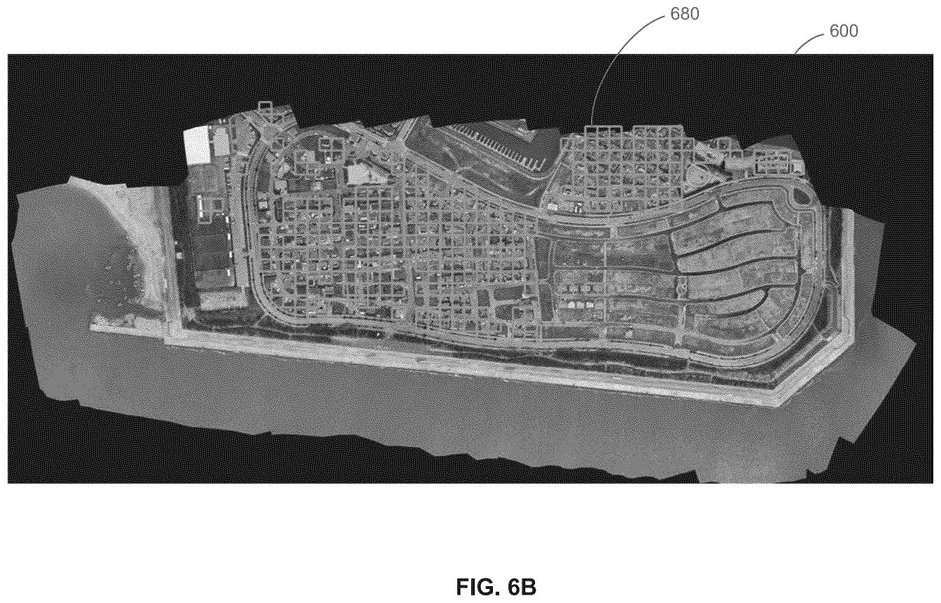

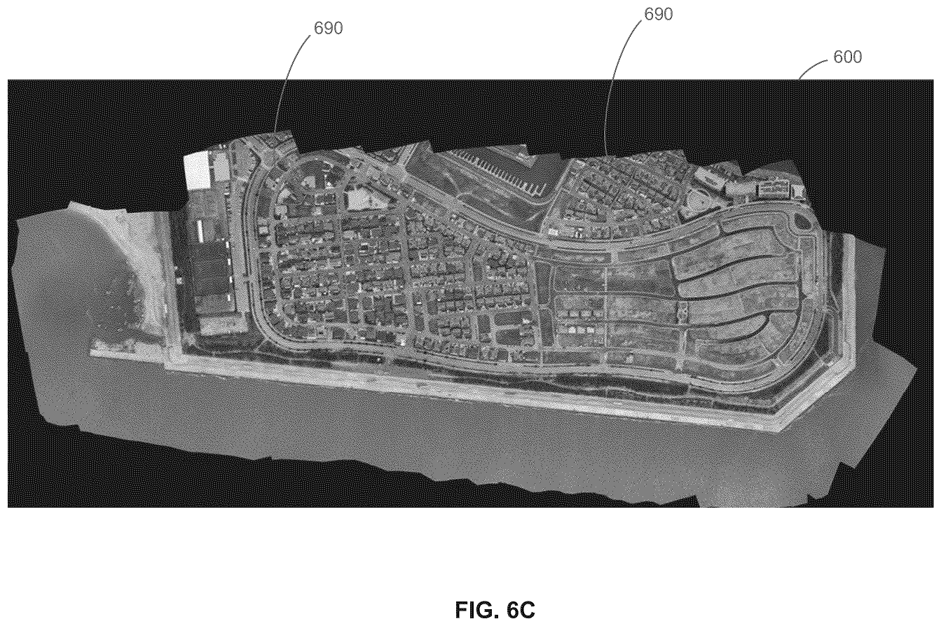

FIG. 6A illustrates an image 600 that may also be captured by imagery sensor 108. Image 600 illustrates a development that may include houses, trees, yards, and other features. Zoom-in view box 654 of area 652 illustrates various features such as rooftops 656. ODC computing device 102 may generate feature vectors based on image 600 (e.g., RGB pixel vectors), and may input the feature vectors to the trained region network. Based on the inputted feature vectors, the trained region network may generate region output data characterizing regions that may include at least one feature of one or more predetermined classes (e.g., classes the region network is trained to detect).

For example, FIG. 6B illustrates regions 680 of image 600 that include at least one feature. Each region 680 may include a predetermined number of pixels. In this example, each region 680 is a square shape, although in other examples, each region can be of other shapes. Only the areas of image 600 that are covered by a region 680 will be processed by the trained feature network. ODC computing device 102 may input region output data characterizing the regions 680 to the trained feature network. Based on the inputted region output data, the trained feature network generates feature output data characterizing detected a particular feature within the regions 680.

For instance, FIG. 6C illustrates features 690 identified within image 600. The features 690 may be rooftops, for example, and the feature network may be trained specifically to detect rooftops within image data. Because the trained region network processed the image 600 to detect regions 680 with at least one object, and the trained feature network processed image data only within the regions 680 (as opposed to the entire image 600), the features 690 can be detected in less time and with reduced processing needs.

Referring back to FIG. 1, the ODC computing device 102 may train the region network based on images with labelled regions (e.g., supervised training), where each region may include objects (e.g., of any class). Regions may be labelled based on whether they include an object. For example, regions that do include objects may be labelled as “positive” regions, while regions that do not include objects may be labelled as “negative” regions. Each region may be defined by pixel coordinates defining a perimeter of the region.

Further, the ODC computing device 102 may train the feature network based on images with identified regions, and with particular features labelled within those regions. For instance, each region may be identified by a bounding box, and one or more features (e.g., rooftops, houses, etc.) may be labelled within each bounding box. The features may be labelled with a corresponding class (e.g., rooftop, ship, house, yard, etc.).

The ODC computing device 102 may train each of the region network and feature network with a number of epochs of corresponding training data, and may further validate each of the region network and feature network based on additional, non-overlapping epochs of corresponding validation data.

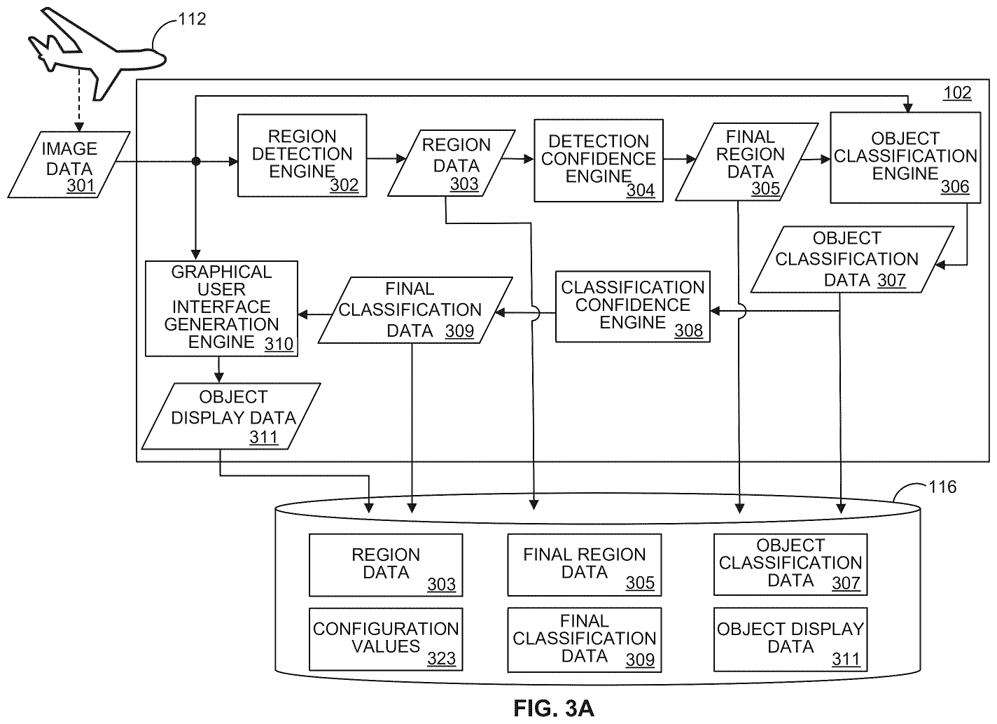

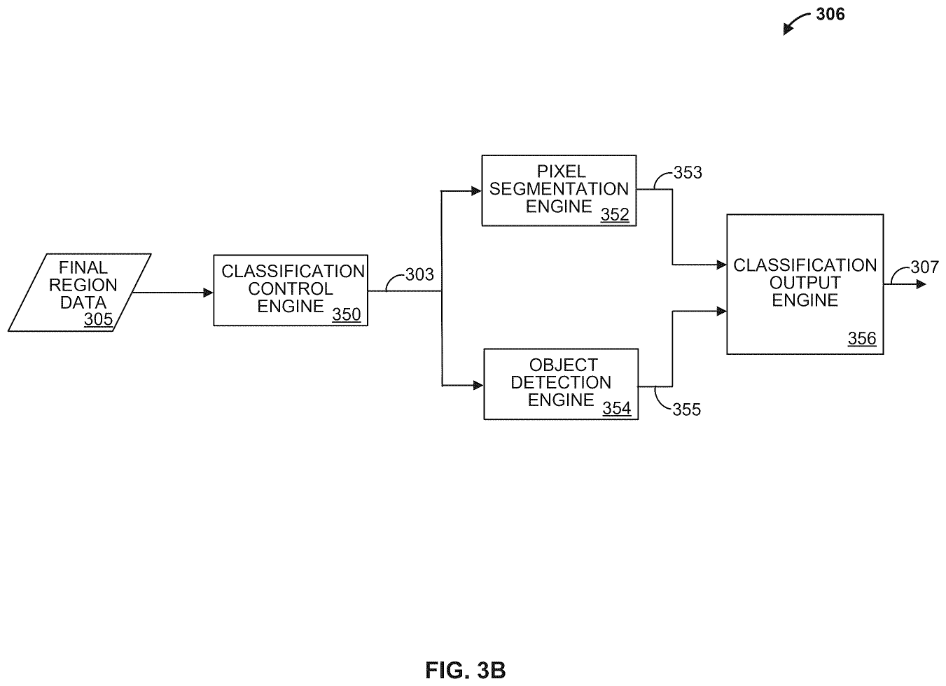

FIG. 3A illustrates exemplary portions of ODC computing device 102. In this example, ODC computing device 102 includes region detection engine 302, detection confidence engine 304, object classification engine 306, classification confidence engine 308, and graphical user interface generation engine 310. In some examples, each of the region detection engine 302, detection confidence engine 304, object classification engine 306, classification confidence engine 308, and graphical user interface generation engine 310 may be implemented in hardware. In some examples, each of the region detection engine 302, detection confidence engine 304, object classification engine 306, classification confidence engine 308, and graphical user interface generation engine 310 may be implemented as an executable program maintained in a tangible, non-transitory memory, such as instruction memory 207 of FIG. 2, that may be executed by one or processors, such as processor 201 of FIG. 2.

As illustrated, region detection engine 302 receives image data 301. The image data 301 may be received from aircraft 112, for example. The region detection engine 302 is configured to apply a trained region network (e.g., a first trained neural network, trained ResNet) to the image data 301. Based on applying the trained region network to the image data 301, the region detection engine 302 generates region data 303 characterizing regions of the image data 301 that may include one or more features of any class. For instance, and as described herein, each region may be defined by a predetermined number of pixels along the X axis and a predetermined of pixels along the Y axis (e.g., 224 pixels by 224 pixels). In some examples, the region detection engine 302 determines the number of regions (e.g., and the size of each region) based on one or more configuration values 323 (e.g., stored in data repository 116). For example, the region detection engine 302 may divide the image data 301 into a number of regions (e.g., 1024) as specified by configuration values 323 identifying a number of rows and a number of columns, where each area defined by a row and column is a region. In addition, the region detection engine 302 applies the trained region network to each region to determine whether each region includes at least one feature. The region data 303 may identify, for each region, a confidence value characterizing a confidence level of whether the region includes at least a predetermined number of features, such as at least one feature. The region detection engine 302 may store the region data 303 within data repository 116.

The detection confidence engine 304 receives the region data 303 and determines, for each region, whether a corresponding threshold is satisfied. For example, the detection confidence engine 304 may determine if the confidence value for each region is beyond (e.g., meets or exceeds) a corresponding threshold. If the confidence value for a region is beyond the threshold, the detection confidence engine 304 generates final region data 305 characterizing and identifying that the corresponding region includes at least one feature. If, however, the confidence value for the region does not meet or exceed the threshold, the detection confidence engine 304 does not generate final region data 305 for the region. As such, the final region data 305 identifies those regions that have been determined to include at least one feature (e.g., of any class). In some examples, the detection confidence engine 304 generates final region data 305 for all regions, and assigns a value to each region based on whether the region includes at least one feature. For example, a first value (e.g., 1) may indicate that the region includes at least one feature, and a second value (e.g., 0) may indicate that the region does not include at least one feature. The detection confidence engine 304 may store the final region data 305 within data repository 116.

Object classification engine 306 receives the final region data 305 as well as the image data 301. As described herein, the final region data 305 identifies regions of the image data 301 that include at least one feature (e.g., of any class). Object classification engine 306 may apply a trained feature network, such as a pixel segmentation network (e.g., U-Net) or an object detection network (e.g., RetinaNet), to the final region data 305 and corresponding portions of the image data 301. Based on applying the trained feature network to the final region data 305 and corresponding portions of the image data 301. The object classification engine 306 generates object classification data 307 characterizing one or more features detected in each of the regions in which the final region data 305 indicates includes at least one feature. For instance, the object classification data 307 may identify a location of each feature (e.g., pixel location, bounding box), and a confidence value for each of one or more classes of features, in a corresponding region. As an example, for each region, the object classification data 307 may include a first value indicating a confidence level that a rooftop was detected, a second value indicating a confidence level that a vehicle was detected, and a third value indicating a confidence level that a yard was detected. The object classification engine 306 may store the object classification data 307 within data repository 116.

The classification confidence engine 308 receives the object classification data 307 and determines, for each detect feature, whether a corresponding threshold is satisfied. For example, the classification confidence engine 308 may determine if the confidence value for each feature is beyond a corresponding threshold. If the confidence value for a feature is beyond the threshold, the classification confidence engine 308 generates final classification data 309 characterizing and identifying detected feature. If, however, the confidence value for the feature does not meet or exceed the threshold, the classification confidence engine 308 does not generate final classification data 309 identifying the feature.

Furthermore, in examples where the object classification data 307 includes confidence values for more than one class of features (e.g., include a first value indicating a confidence level that a rooftop was detected, a second value indicating a confidence level that a vehicle was detected, and a third value indicating a confidence level that a yard was detected), the classification confidence engine 308 may select the class with the highest confidence value, and generate the final classification data 309 for the selected class when the highest confidence value is beyond the corresponding threshold. The classification confidence engine 308 may store the final classification data 309 within data repository 116.

Graphical user interface generation engine 310 may receive the final classification data 309 and, in some examples, the image data 301. Graphical user interface generation engine 310 may generate graphical elements identifying the detected features. For instance, graphical user interface generation engine 310 may generate graphical elements such as the graphical elements for features 590, 690. In some examples, graphical user interface generation engine 310 may overlay the graphical elements over portions of the image data 301. The graphical user interface generation engine 310 may package the graphical elements within object display data 311, and may provide the object display data 311 for display. For instance, the ODC computing device 102 may display the object display data 311 within display 206. Additionally or alternatively, the graphical user interface generation engine 310 may store the object display data 311 within data repository 116.

FIG. 3B illustrates an example of the object classification engine 306. In this example, the object classification engine 306 includes a classification control engine 350, a pixel segmentation engine 352, an object detection engine 354, and a classification output engine 356. The classification control engine 350 receives the final region data 305, and can provide the final region data 305 to one or both of the pixel segmentation engine 352 and object detection engine 354. For example, a configuration value 323 may determine whether one or more of the pixel segmentation engine 352 and object detection engine 354 are enabled. The classification control engine 350 may provide the final region data 305 to any of the pixel segmentation engine 352 and object detection engine 354 that are enabled.

The pixel segmentation engine 352 is configured to apply a trained pixel segmentation network (e.g., U-Net) to the final region data 305 and, based on the application of the trained pixel segmentation network to the final region data 305, generate pixel segmentation output data 353 characterizing detected features. For example, the pixel segmentation output data 353 may identify, for each detected feature, a pixel location of the feature (e.g., the center of the detected object), and a corresponding confidence value for the feature.

The object detection engine 354 is configured to apply a trained object detection model (e.g., RetinaNet) to the final region data 305 and, based on the application of the trained object detection model to the final region data 305, generate object detection data 355 characterizing detected features. For example, the object detection data 355 may identify, for each detected feature, a bounding box that includes the feature, and a corresponding confidence value for the feature.

The classification output engine 356 may receive one or more of the pixel segmentation output data 353 and the object detection data 355 and, based on the one or more of the pixel segmentation output data 353 and the object detection data 355, output object classification data 307. For example, in some instances, when just one of the pixel segmentation output data 353 and the object detection data 355 are generated, the classification output engine 356 provides the one of the pixel segmentation output data 353 and the object detection data 355 that is generated as object classification data 307.

In some instances, when both of the pixel segmentation output data 353 and the object detection data 355 are generated, the classification output engine 356 may determine whether, for a feature identified in the pixel segmentation output data 353, a corresponding feature appears at or within a threshold distance in the object detection data 355. For instance, the classification output engine 356 may determine whether the object detection data 355 identifies a feature within a bounding box that includes a pixel location identifying the center of an object in the pixel segmentation output data 353. If the features are identified at or within a threshold distance of each other, the classification output engine 356 may generate object classification data 307 identifying and characterizing the feature (e.g., based on one or more of the corresponding object detection data 355 and pixel segmentation output data 353). Otherwise, object classification data 307 is not generated for the feature. In some examples, the classification output engine 356 combines the pixel segmentation output data 353 with the object detection data 355, and provides the combination as object classification data 307.

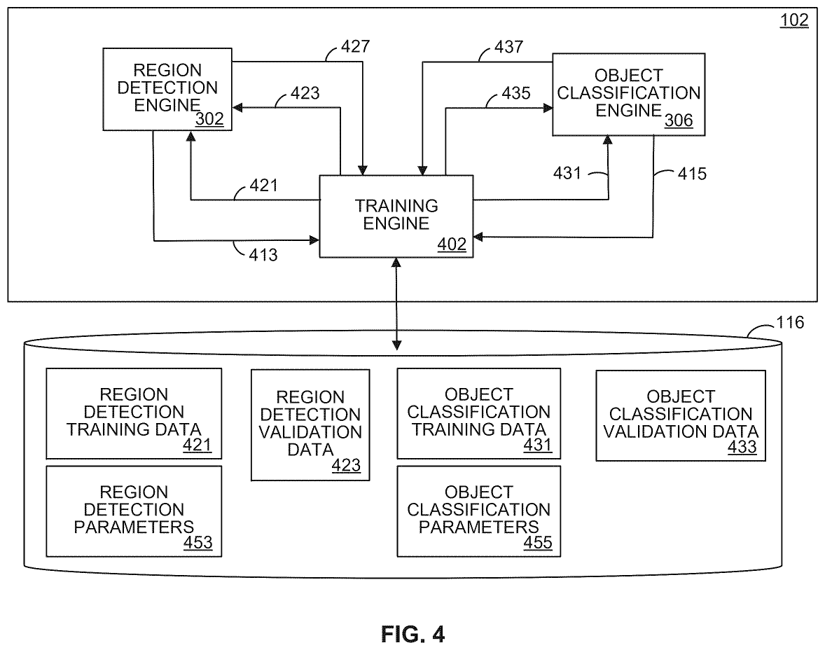

FIG. 4 illustrates exemplary portions of the ODC computing device 102 and, more specifically, training processes to train the region and feature networks described herein. Here, training engine 402 may obtain one or more epochs of region detection training data 421. The region detection training data 421 may include images with labelled regions identifying that those regions include at least one feature (e.g., of any class). The training engine 402 may transmit the region detection training data 421 to the region detection engine 302. The region detection engine 302 receives the region detection training data 421, and inputs the region detection training data 421 to a region network (e.g., ResNet). In response, the region network generates region output data 413 characterizing regions with at least one feature. The training engine 402 may compare the region output data 413 to ground truth data and, based on the comparison, may determine at least one metric. The metric may be, for example, a loss function, such as a computed precision value, a computed recall value, or a computed area under curve (AUC) for receiver operating characteristic (ROC) curves or precision-recall (PR) curves, for example. Further, the training engine 402 may determine whether the region network is sufficiently trained based on the computed metric. For example, the training engine 402 may determine that the region network is sufficiently trained when the metric is beyond a corresponding threshold.

In some examples, the training engine 402 may validate the trained region network based on region detection validation data 423. The region detection validation data 423 may include images, such as images 500, 600. The training engine 402 may transmit epochs of region detection validation data 423 to the region detection engine 302. The region detection engine 302 receives the region detection validation data 423, and inputs the region detection validation data 423 to the initially trained region network. In response, the initially trained region network generates region output data 427 characterizing regions with at least one feature. The training engine 402 may compare the region output data 427 to ground truth data and, based on the comparison, may determine at least one metric. Further, the training engine 402 may determine whether the region network is sufficiently validated based on the computed metric. For example, the training engine 402 may determine that the region network is sufficiently validated when the metric is beyond a corresponding threshold.

Similarly, the training engine 402 may obtain one or more epochs of object classification training data 431 to train the feature network of the object classification engine 306. The object classification training data 431 may include images with labelled features of a particular class (e.g., rooftops, ships), such as features within particularly labelled regions of the images. The training engine 402 may transmit the object classification training data 431 to the object classification engine 306. The object classification engine 306 receives the object classification training data 431 may, and inputs the object classification training data 431 may to a feature network pixel, such as a pixel segmentation network (e.g., U-Net) or object detection model (e.g., RetinaNet). In response, the feature network generates feature output data 415 characterizing detected features. The training engine 402 may compare the feature output data 415 to ground truth data and, based on the comparison, may determine at least one metric. The metric may be, for example, a loss function, such as a computed precision value, a computed recall value, or a computed area under curve (AUC) for receiver operating characteristic (ROC) curves or precision-recall (PR) curves, for example. Further, the training engine 402 may determine whether the feature network is sufficiently trained based on the computed metric. For example, the training engine 402 may determine that the feature network is sufficiently trained when the metric is beyond a corresponding threshold.

In some examples, the training engine 402 may validate the trained feature network based on object classification validation data 433. The object classification validation data 433 may include images with regions, such as image 500 with regions 580, and image 600 with regions 680. The training engine 402 may transmit epochs of object classification validation data 433 to the object classification engine 306. The object classification engine 306 receives the object classification validation data 433, and inputs the object classification validation data 433 to the initially trained feature network. In response, the initially trained feature network generates feature output data 437 characterizing features detected within the one or more regions. The training engine 402 may compare the feature output data 437 to ground truth data and, based on the comparison, may determine at least one metric. Further, the training engine 402 may determine whether the feature network is sufficiently validated based on the computed metric. For example, the training engine 402 may determine that the feature network is sufficiently validated when the metric is beyond a corresponding threshold.

The training engine 402 may store parameters characterizing the trained and valued region network in the data repository 116 as region detection parameters 453. The region detection parameters 453 can include, for example, hyperparameters, weights, coefficients, and any other data characterizing the trained and validated region network. Similarly, the training engine 402 may store parameters characterizing the trained and validated feature network in the data repository 116 as object classification parameters 455. The object classification parameters 455 can include, for example, hyperparameters, weights, coefficients, and any other data characterizing the trained and validated feature network.

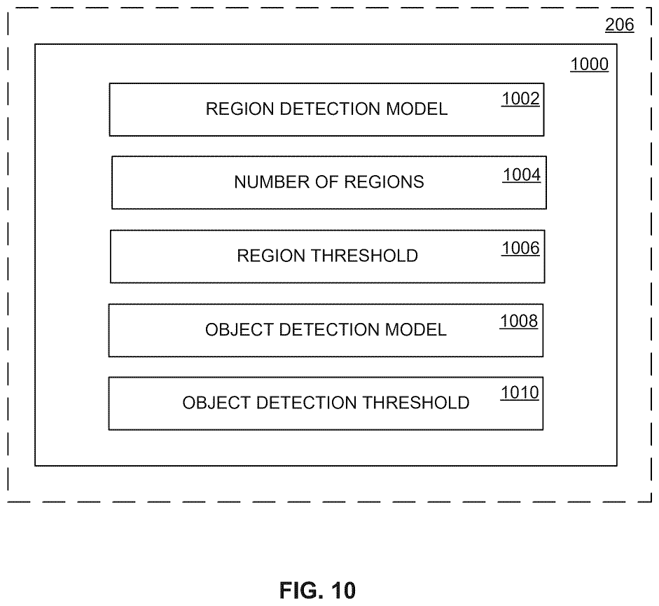

FIG. 10 illustrates a graphical user interface 1000 that can be used to configure the machine learning models described herein. For example, ODC computing device 102 may generate graphical user interface 1000, and may display graphical user interface 1000 within a display, such as display 206. As illustrated, graphical user interface 1000 includes a region detection model icon 1002, a number of regions icon 1004, a region threshold icon 1006, an object detection model icon 1008, and an object detection threshold icon 1010. Each of the icons may be, for example, selection lists, drop-down lists, search icons, or any other suitable icons that allow a user to select the corresponding items.

Region detection model icon 1002 allows a user to select (e.g., enable) a region network (e.g., a ResNet model). As described herein, the region network can be applied to image data, and may generate output data characterizing regions that include at least one object (e.g., of a predetermined number of classes). In some examples, a first region network is configured to determine that a region includes an object of a first set of classes, whereas a second region network is configured to determine that a region includes an object of a second set of classes. The second set of classes may include a different set of classes than the first set of classes. In addition, the number of regions icon 1005 allows the user to configure a number of regions for the selected region network. For example, if the user selects 1024, then the region network will divide an image into 1024 regions, and perform operations to determine whether the regions include at least one object. Region threshold icon 1006 allows a user to set a threshold value for regions determined by the region network. For instance, as described herein, a region with a confidence value less than the threshold value is not included in final region data (e.g., final region data 305), whereas a region with a confidence value that meets or exceeds the threshold value is included in the final region data.

The object detection model icon 1008 allows a user to select a feature network. For example, the object detection model icon 1008 may allow the user to select a pixel segmentation network such as a convolutional neural network (e.g., U-Net model), and/or an object detection network, such as one-stage object detection model (e.g., RetinaNet). As described herein, in some examples, the user selects a pixel segmentation network and an object detection network, and each of them process image data within regions identified by the region network. Object detection threshold icon 1010 allows a user to set a threshold value for features determined by the feature network. For instance, as described herein, a feature with a confidence value less than the threshold value is not included in final classification data (e.g., final classification data 309), whereas a feature with a confidence value that meets or exceeds the threshold value is included in the final classification data.

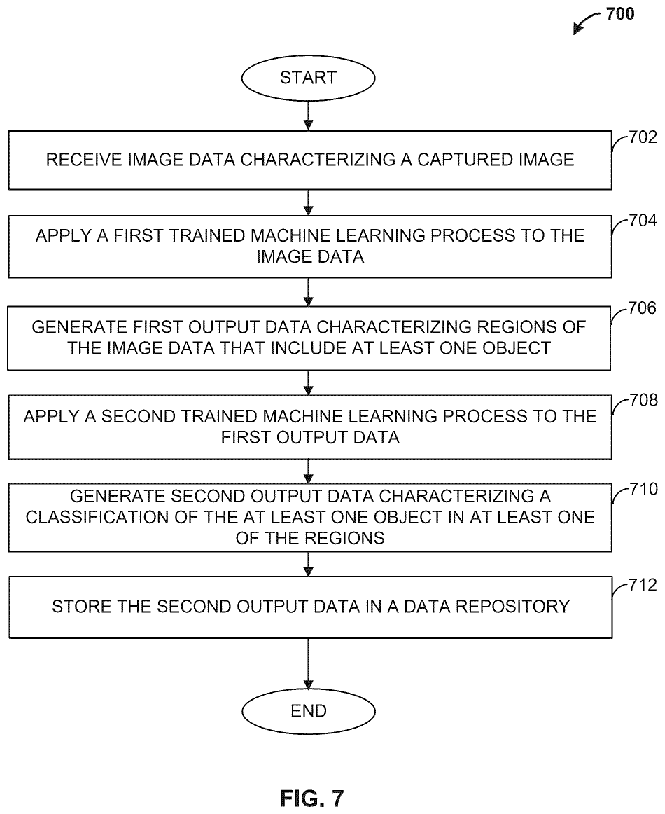

FIG. 7 illustrates a flowchart of an exemplary method 700 that can be carried out by a computing device such as, for example, ODC computing device 102.

Beginning at block 702, image data characterizing a captured image is received. For example, the ODC computing device 102 may receive image data from aircraft 112. At block 704, a first trained machine learning process is applied to the image data. For instance, the ODC computing device 102 may apply a first trained neural network (e.g., ResNet) to the image data. At block 706, based on the application of the first trained machine learning process to the image data, the ODC computing device 102 generates first output data characterizing regions of the image data that include at least one detected object.

Proceeding to block 708, a second trained machine learning process is applied to the first output data. For example, the ODC computing device 102 may apply a second trained neural network, such as a pixel segmentation network (e.g., U-Net) or object detection model (e.g., RetinaNet), to the first output data. At block 710, based on the application of the second trained machine learning process to the first output data, the ODC computing device 102 generates second output data characterizing a classification of at least one object in at least one of the regions. The second trained neural network attempts to detect the features only within the regions identified by the first output data. In some examples, the second trained neural network searches areas of the image data that include the regions, and extend a predetermined distance away from the regions, to allow for region boundary detections. At block 712, the ODC computing device 102 stores the second output data in a data repository (e.g., data repository 116).

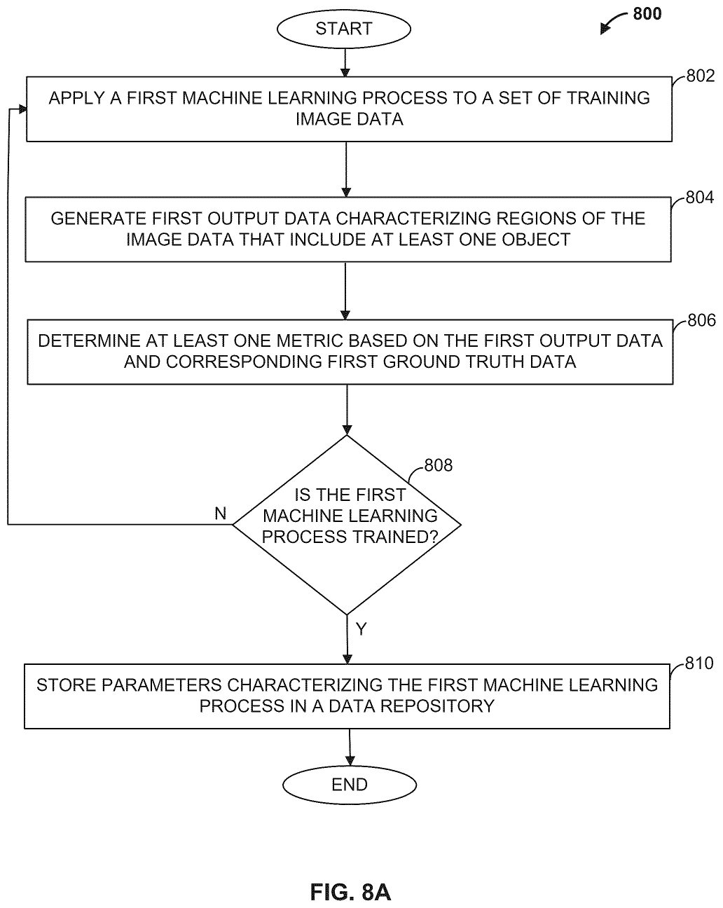

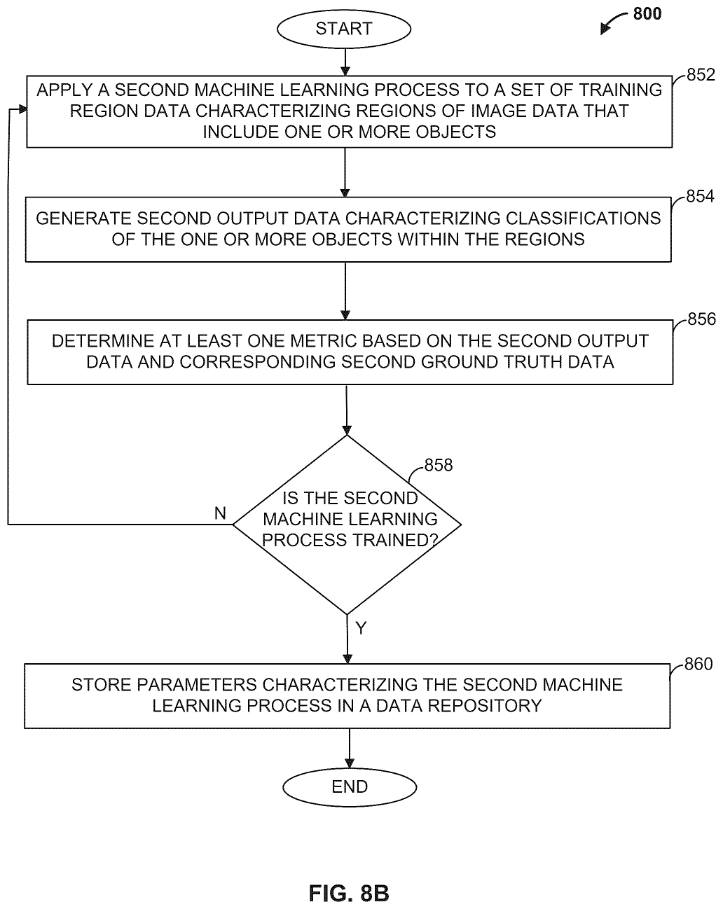

FIG. 8A illustrates a flowchart of an exemplary method 800 that can be carried out by a computing device such as, for example, ODC computing device 102.

Beginning at block 802, a first machine learning process is applied to a set of training image data. For example, the ODC computing device 102 may input region detection training data 421 to the first machine learning process (e.g., ResNet model). At block 804, based on the application of the first machine learning process, first output data is generated. The first output data characterizes regions of the image data that include at least one object.

Proceeding to block 806, at least one metric is determined based on the first output data and corresponding first ground truth data. For example, the ODC computing device 102 may compute a loss function, such as a computed precision value, a computed recall value, or a computed area under curve (AUC) for receiver operating characteristic (ROC) curves or precision-recall (PR) curves, based on the first output data and corresponding first ground truth data.

At block 808, the ODC computing device 102 determines if the first machine learning process is trained based on the at least one metric. For example, the ODC computing device 102 may compare the metric to a threshold. If the metric is beyond the metric, the ODC computing device 102 determines that the first machine learning process is sufficiently trained. If the first machine learning process is not sufficiently trained, the method proceeds back to block 802 to continue training the first machine learning process. Otherwise, if the first machine learning process is sufficiently trained, the method proceeds to block 810. At block 810, parameters characterizing the first machine learning process are stored in a data repository, such as data repository 116. The trained first machine learning process may be established based on the stored parameters.

FIG. 8B illustrates a flowchart of an exemplary method 850 that can be carried out by a computing device such as, for example, ODC computing device 102.

Beginning at block 852, a second machine learning process is applied to a set of training region data that characterizes regions of image data that include objects. For example, the ODC computing device 102 may input object classification training data 431 to the second machine learning process (e.g., a pixel segmentation network (e.g., U-Net) or object detection model (e.g., RetinaNet)). At block 854, based on the application of the second machine learning process, second output data is generated. The second output data characterizes classifications of detected objects within the one or more regions.

Proceeding to block 856, at least one metric is determined based on the second output data and corresponding second ground truth data. For example, the ODC computing device 102 may compute a loss function, such as a computed precision value, a computed recall value, or a computed area under curve (AUC) for receiver operating characteristic (ROC) curves or precision-recall (PR) curves, based on the second output data and corresponding second ground truth data.

At block 858, the ODC computing device 102 determines if the second machine learning process is trained based on the at least one metric. For example, the ODC computing device 102 may compare the metric to a threshold. If the metric is beyond the metric, the ODC computing device 102 determines that the second machine learning process is sufficiently trained. If the second machine learning process is not sufficiently trained, the method proceeds back to block 852 to continue training the second machine learning process. Otherwise, if the second machine learning process is sufficiently trained, the method proceeds to block 860. At block 860, parameters characterizing the second machine learning process are stored in a data repository, such as data repository 116. The trained second machine learning process may be established based on the stored parameters.

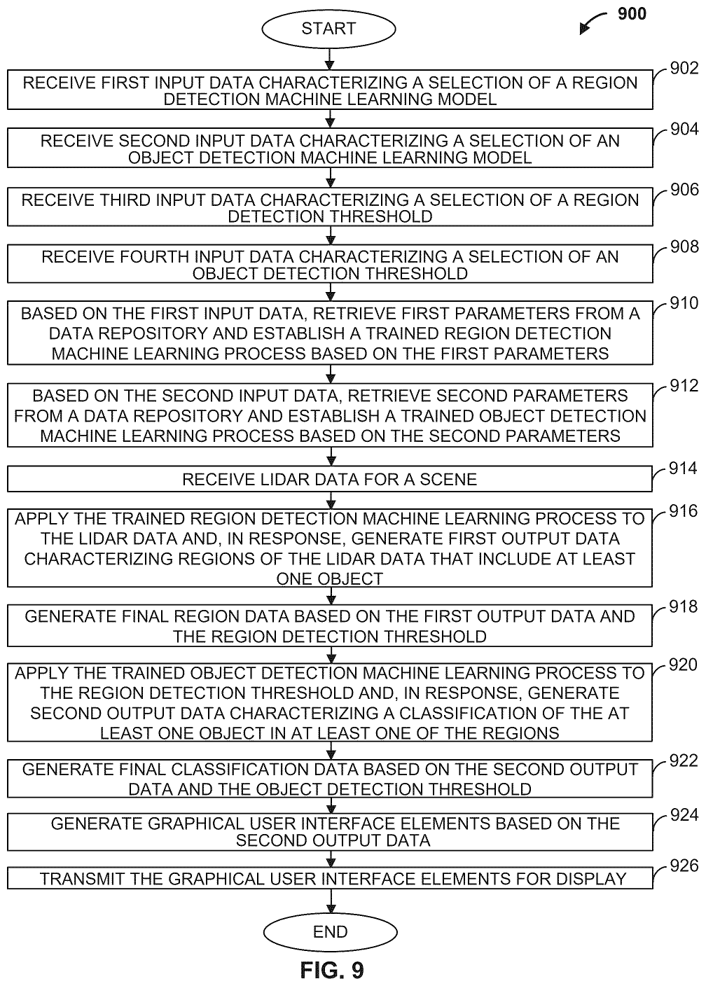

FIG. 9 illustrates a flowchart of an exemplary method 900 that can be carried out by a computing device such as, for example, ODC computing device 102.

Beginning at block 902, first input data is received. The first input data characterizes a selection of a region detection machine learning model (e.g., a ResNet model). At block 904, second input data is received. The second input data characterizes a selection of an object detection machine learning model (e.g., a U-Net model, RetinaNet model). Further, at block 906, third input data is received. The third input data characterizes a selection of a region detection threshold. At block 908, fourth input data is received. The fourth input data characterizes a selection of an object detection threshold.

Proceeding to block 910, based on the first input data, first parameters are retrieved from a data repository. Further, the ODC computing device 102 establishes a trained region detection machine learning process based on the first parameters. For example, the first parameters may include weights. The selected model may be configured based on the weights. At block 912, based on the second input data, second parameters are retrieved from the data repository. Further, the ODC computing device 102 establishes a trained object detection machine learning process based on the second parameters.

Further, at block 914, LIDAR data is received for a scene. At block 916, the trained region detection machine learning process is applied to the LIDAR data and, in response, first output data is generated. The first output data characterizes regions of the LIDAR data that include at least one object (e.g., of any class). At block 918, final region data is generated based on the first output data and the region detection threshold. For instance, the final region data (e.g., final region data 305) may include regions of first output data that that include a confidence value that is at or above the region detection threshold. In some examples, regions of first output data that include a confidence value that is below the region detection threshold are not added to the final region data (e.g., they are removed from the first output data to generate the final region data).

Further, at block 920, the trained object detection machine learning process is applied to the final region data and, in response, second output data is generated. The second output data characterizes a classification (e.g., rooftop) of at least one object in at least one of the regions. At block 922, final classification data is generated based on the second output data and the object detection threshold. For instance, the final classification data (e.g., final classification data 309) may include second output data classifications with a confidence value that is at or above the object detection threshold. In some examples, second output data classifications are not added to the final classification data when a classification's corresponding confidence value is below the object detection threshold (e.g., they are removed from the second output data to generate the final classification data).

Proceeding to block 924, graphical user interface elements are generated based on the second output data. For instance, the graphical user elements may include identified portions of the scene that include the detected object, among other examples. At block 926, the graphical user interface elements are transmitted for display. For example, the ODC computing device 102 may transmit the graphical user interface elements for display on another device (e.g., cellphone, laptop, smartphone), or any other suitable display (e.g., display 206).

In some implementations, a computing device includes a memory device, and at least one processor communicatively coupled to the memory device. The at least one processor is configured to receive image data (e.g., geospatial data, Light Detection and Ranging (LIDAR) data, camera data, video data, etc.) characterizing a captured image. The at least one processor is also configured to apply a first trained machine learning process to the image data and, based on the application of the first trained machine learning process to the image data, generate first output data characterizing regions of the image data that include at least one object. Further, the at least one processor is configured to apply a second trained machine learning process to the first output data and, based on the application of the second trained machine learning process to the first output data, generate second output data characterizing a classification of the at least one object in at least one of the regions. The at least one processor is also configured to store the second output data in a data repository. The at least one processor may also be configured to transmit the second output data for display.

In some implementations, the first output data comprises a confidence value for each of the regions, and the at least one processor is configured to determine that the confidence value for at least one of the regions is beyond a region detection threshold. In some implementations, the at least one processor is configured to determine that the confidence value for at least one of the regions is not beyond the region detection threshold, and adjust the first output data to remove the corresponding region based on the determination.

In some implementations, the second output data comprises a confidence value for each classification, and the at least one processor is configured to determine that the confidence value for at least one of the classifications is beyond an object detection threshold. In some implementations, the at least one processor is configured to determine that the confidence value for at least one of the classifications is not beyond the object detection threshold, and adjust the second output data to remove the classification based on the determination.

In some implementations, each of the regions comprise a corresponding portion of the image data.

In some implementations, the first trained machine learning process is based on a residual network.

In some implementations, the at least one object is of any of a predetermined number of classes.

In some implementations, the second trained machine learning process is based on a pixel segmentation network. In some implementations, the second output data comprises, for each classification, a pixel location, a class value, and a confidence value.

In some implementations, the second trained machine learning process is based on an object detection network. In some implementations, the second output data comprises, for each classification, a bounding box, a class value, and a confidence value.

In some implementations, the classification of the at least one object is one of a rooftop and a ship.

In some implementations, the at least one processor is configured to generate at least one graphical user interface element based on the second output data, and transmit the at least one graphical user interface element for display.

In some implementations, the at least one processor is configured to train the first trained machine learning process based on epochs of training image data comprising labelled regions. In some implementations, the at least one processor is configured to validate the first trained machine learning process based on epochs of validating image data comprising regions.

In some implementations, the at least one processor is configured to train the second trained machine learning process based on epochs of training image data comprising labelled objects within regions. In some implementations, the at least one processor is configured to validate the second trained machine learning process based on epochs of validating image data comprising objects within labelled regions.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a memory device; and
at least one processor communicatively coupled to the memory device, wherein the at least one processor is configured to:
receive image data characterizing a captured image;
apply a first trained machine learning process to the image data and, based on the application of the first trained machine learning process to the image data, generate first output data characterizing regions of the image data that include at least one object;
apply a second trained machine learning process to the first output data and, based on the application of the second trained machine learning process to the first output data, generate second output data characterizing a classification of the at least one object in at least one of the regions; and
store the second output data in a data repository.

2. The system of claim 1, wherein the first output data comprises a confidence value for each of the regions, and wherein the at least one processor is configured to determine that the confidence value for at least one of the regions is beyond a region detection threshold.

3. The system of claim 2, wherein the at least one processor is configured to:
determine that the confidence value for at least one of the regions is not beyond the region detection threshold; and
adjust the first output data to remove the corresponding region based on the determination.

4. The system of claim 1, wherein the second output data comprises a confidence value for each classification, and wherein the at least one processor is configured to determine that the confidence value for at least one of the classifications is beyond an object detection threshold.

5. The system of claim 4, wherein the at least one processor is configured to:
determine that the confidence value for at least one of the classifications is not beyond the object detection threshold; and
adjust the second output data to remove the classification based on the determination.

6. The system of claim 1, wherein each of the regions comprise a corresponding portion of the image data.

7. The system of claim 1, wherein the first trained machine learning process is based on a residual network.

8. The system of claim 1, wherein the at least one object is of any of a predetermined number of classes.

9. The system of claim 1, wherein the second trained machine learning process is based on a pixel segmentation network.

10. The system of claim 9, wherein the second output data comprises, for each classification, a pixel location, a class value, and a confidence value.

11. The system of claim 1, wherein the second trained machine learning process is based on an object detection network.

12. The system of claim 11, wherein the second output data comprises, for each classification, a bounding box, a class value, and a confidence value.

13. The system of claim 1, wherein the classification of the at least one object is one of a vehicle and infrastructure.

14. The system of claim 1, wherein the at least one processor is configured to:
generate at least one graphical user interface element based on the second output data; and
transmit the at least one graphical user interface element for display.

15. The system of claim 1, wherein the at least one processor is configured to train the first trained machine learning process based on epochs of training image data comprising labelled regions.

16. The system of claim 15, wherein the at least one processor is configured to validate the first trained machine learning process based on epochs of validating image data comprising regions.

17. The system of claim 1, wherein the at least one processor is configured to train the second trained machine learning process based on epochs of training image data comprising labelled objects within regions.

18. The system of claim 17, wherein the at least one processor is configured to validate the second trained machine learning process based on epochs of validating image data comprising objects within labelled regions.

19. A method by at least one processor comprising:
receiving image data characterizing a captured image;
applying a first trained machine learning process to the image data and, based on the application of the first trained machine learning process to the image data, generate first output data characterizing regions of the image data that include at least one object;
applying a second trained machine learning process to the first output data and, based on the application of the second trained machine learning process to the first output data, generate second output data characterizing a classification of the at least one object in at least one of the regions; and
storing the second output data in a data repository.

20. A non-transitory computer readable medium having instructions stored thereon, wherein the instructions, when executed by at least one processor, cause a device to perform operations comprising:
receiving image data characterizing a captured image;
applying a first trained machine learning process to the image data and, based on the application of the first trained machine learning process to the image data, generate first output data characterizing regions of the image data that include at least one object;
applying a second trained machine learning process to the first output data and, based on the application of the second trained machine learning process to the first output data, generate second output data characterizing a classification of the at least one object in at least one of the regions; and
storing the second output data in a data repository.
